(19) United States
(12) Patent Application Publication
(10) Pub. No.: US 2021/0089246 A1
(43) Pub. Date: Mar. 25, 2021

(54) NON-TRANSITORY COMPUTER-READABLE STORAGE MEDIUM AND COMMUNICATION PROCESSING SYSTEM

(71) Applicant: BROTHER KOGYO KABUSHIKI KAISHA, Nagoya (JP)

(72) Inventor: Yusuke Miyajima, Nagoya (JP)

(21) Appl. No.: 17/026,070

(22) Filed: Sep. 18, 2020

(30) Foreign Application Priority Data
Sep. 20, 2019 (JP) 2019-172338

(51) Int. Cl. G06F 3/12

(52) U.S. Cl. CPC G06F 3/1205; G06F 3/1292; G06F 3/126; G06F 3/1232; G06F 3/1256; G06F 3/1293

(57) ABSTRACT

An operation terminal is caused to perform: acquiring an acquisition result including identification information of each of at least one printing apparatus and medium information of each printing medium mounted to a corresponding printing apparatus of the at least one printing apparatus, the acquisition result being broadcasted from the at least one printing apparatus; displaying, on a display, a display result including the acquired identification information of each of the at least one printing apparatus and the acquired medium information of each printing medium mounted to the corresponding printing apparatus of the at least one printing apparatus; and receiving, via an operation unit, a decision operation of selecting one of the at least one printing apparatus or the printing medium mounted to one of the at least one printing apparatus as a selection target, in correspondence to the display result displayed on the display.

### CROSS-REFERENCE TO RELATED APPLICATIONS

This application is based upon and claims the benefit of priority from prior Japanese patent application No. 2019-172338, filed on Sep. 20, 2019, the entire contents of which are incorporated herein by reference.

### TECHNICAL FIELD

The present disclosure relates to non-transitory computer-readable storage medium storing a computer program that is executed by a computer of an operation terminal configured to perform wireless communication with a printing apparatus, and a communication processing system including the printing apparatus and the operation terminal.

### BACKGROUND ART

Known is a printing apparatus capable of performing communication with an operation terminal via wireless communication (for example, refer to JP-A-2014-191418). In the printing apparatus (printed label production apparatus) of the related art, for example, when printing data is received from an external device (operation terminal), printing corresponding to the printing data is performed on a printing medium (tape for label) being conveyed.

In the meantime, when there is a plurality of printed media in a usable state in an office and the like, for example, there may be a need to first consume the printing medium that is already in use as much as possible so as to prevent the printing medium that is being used (in use) from unnecessarily increasing. The printing medium in use is in a state of being mounted in the printing apparatus, in many cases.

### SUMMARY

Therefore, when the printing apparatus performs wireless communication with the operation terminal as described above, if medium information of the mounted printing medium is transmitted to the operation terminal, a user can check on the operation terminal which of the printed media is currently mounted in a usable state in the printing apparatus, which is convenient. However, the above technology of the related art does not particularly consider this point.

An aspect of the present disclosure is to provide a non-transitory computer-readable storage medium and a communication processing system that allow a user to confirm that a printing medium being looked for is mounted in a printing apparatus and can improve convenience.

According to an aspect of the present disclosure, there is provided a non-transitory computer-readable storage medium storing a computer program readable by a computer of an operation terminal, the operation terminal including a communication unit connected to, by wireless communication, at least one printing apparatus configured to perform printing on a printing medium mounted thereto, a display configured to display information, an operation unit, and the computer, and the computer program, when executed by the computer, causing the operation terminal to perform: acquiring an acquisition result including identification information of each of the at least one printing apparatus and medium information of each printing medium mounted to a corresponding printing apparatus of the at least one printing apparatus, the acquisition result being broadcasted from the at least one printing apparatus; displaying, on the display, a display result including the acquired identification information of each of the at least one printing apparatus and the acquired medium information of each printing medium mounted to the corresponding printing apparatus of the at least one printing apparatus; and receiving, via the operation unit, a decision operation of selecting one of the at least one printing apparatus or the printing medium mounted to one of the at least one printing apparatus as a selection target, in correspondence to the display result displayed on the display.

According to another aspect of the present disclosure, there is provided a communication processing system including: at least one printing apparatus including: a conveyor configured to convey a printing medium mounted thereto; a printing part configured to perform printing on the printing medium; a communication part configured to perform wireless communication with an operation terminal; a notification part configured to issue a predetermined notification; and a first controller; and the operation terminal including: an operation unit; a display configured to display information; a communication unit configured to perform the wireless communication with the communication part; and a second controller, wherein the first controller of the at least one printing apparatus is configured to: acquire medium information of the printing medium mounted to the at least one printing apparatus; and broadcast, via the communication part, the acquired medium information and identification information of the at least one printing apparatus, wherein the second controller of the operation terminal is configured to: receive, via the communication unit, a received result including the identification information of each of the at least one printing apparatus and the medium information of each printing medium mounted to a corresponding printing apparatus of the at least one printing apparatus which are broadcasted from the at least one printing apparatus; display, on the display, a display result including the received identification information of each of the at least one printing apparatus and the received medium information of each printing medium mounted to the corresponding printing apparatus of the at least one printing apparatus; receive, via the operation unit, a decision operation of selecting one of the at least one printing apparatus or the printing medium mounted to one of the at least one printing apparatus as a selection target, in correspondence to the display result displayed on the display; and transmit, by wireless communication via. the communication unit, an execution instruction for executing a predetermined notification operation to the one of the at least one printing apparatus corresponding to the selection target for which the decision operation is received, and wherein the first controller of the one of the at least one printing apparatus is configured to cause the notification part to execute the predetermined notification operation based on the transmitted execution instruction.

### BRIEF DESCRIPTION OF DRAWINGS

FIG. 1 is a system configuration view depicting an entire configuration of a printing processing system in accordance with an embodiment of the present disclosure;

FIG. 2 is a functional block diagram depicting a functional configuration of the printing processing system;

FIG. 3A to 3D illustrate screen transition on a touch panel of an operation terminal;

FIG. 4 illustrates an example of a notification operation of a. label printer;

FIG. 5 is a flowchart depicting a processing procedure that is executed by a control unit of the operation terminal;

FIGS. 6A to 6D illustrate screen transition on the touch panel of the operation terminal, in a modified embodiment in which a distance to each label printer is also displayed;

FIG. 7 is a flowchart depicting processing procedures that are executed by the control unit of the operation terminal;

FIG. 8A to 8D illustrate screen transition on the touch panel of the operation terminal, in a modified embodiment in which a search condition is automatically set;

FIG. 9 is a flowchart depicting a processing procedure that is executed by the control unit of the operation terminal;

FIGS. 10A to 10D illustrate screen transition on the touch panel of the operation terminal, in a modified embodiment corresponding to a case where there is no cartridge matching the search condition; and

FIG. 11 is a flowchart depicting a processing procedure that is executed by the control unit of the operation terminal.

### DESCRIPTION OF EMBODIMENTS

Hereinbelow, embodiments of the present disclosure will be described with reference to the drawings.

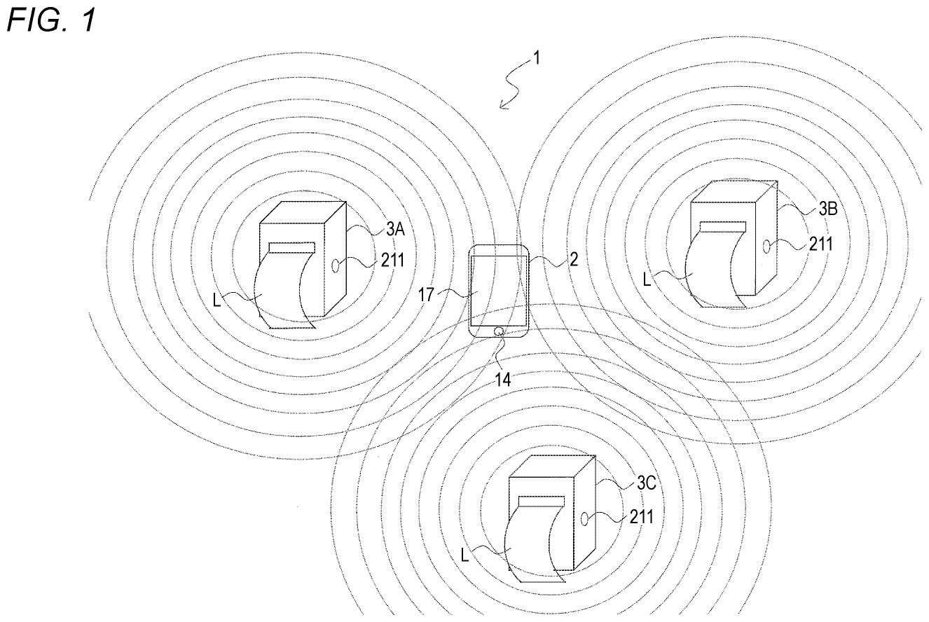

An embodiment of the present disclosure is described with reference to FIGS. 1 to 5.

<Configuration of Printing Processing System>

First, an entire configuration of a printing processing system of the present embodiment is described with reference to FIG. 1.

As shown in FIG. 1, a printing processing system 1 of the present embodiment includes an operation terminal 2, and at least one (three, in the present example) label printer 3A, 3B and 3C. The label printers 3A, 3B and 3C can connect to the operation terminal 2 via Bluetooth (registered trademark) wireless communication (hereinbelow, simply referred to as “Bluetooth communication”). In other words, the label printers 3A, 3B and 3C are within a communication range by Bluetooth communication from the operation terminal 2. As a result, data can be transmitted and received between each of the label printers 3A, 3B and 3C and the operation terminal 2. In the meantime, when collectively referring to “label printers 3A, 3B and 3C” without distinguishing the same, they are simply referred to as “label printer 3”. Also, the printing processing system 1 corresponds to an example of the communication processing system defined in the claims, and the label printer 3 corresponds to an example of the printing apparatus.

The operation terminal 2 is a so-called smartphone having an operation button 14 and a touch panel 17 that is a display having a display function and enabling a touch operation. In the meantime, the operation terminal 2 is not limited to the smartphone and may be a so-called feature phone, a tablet-type computer, a laptop computer, a desktop computer or the like, and the display is not limited to the touch panel 17.

The label printer 3 is configured to transmit and receive a variety of information and instruction signals to and from the operation terminal 2, and to produce a printed label L having a desired print such as a text and an image thereon, based on an operation of a user who is an operator of the operation terminal 2.

<Functional Configuration>

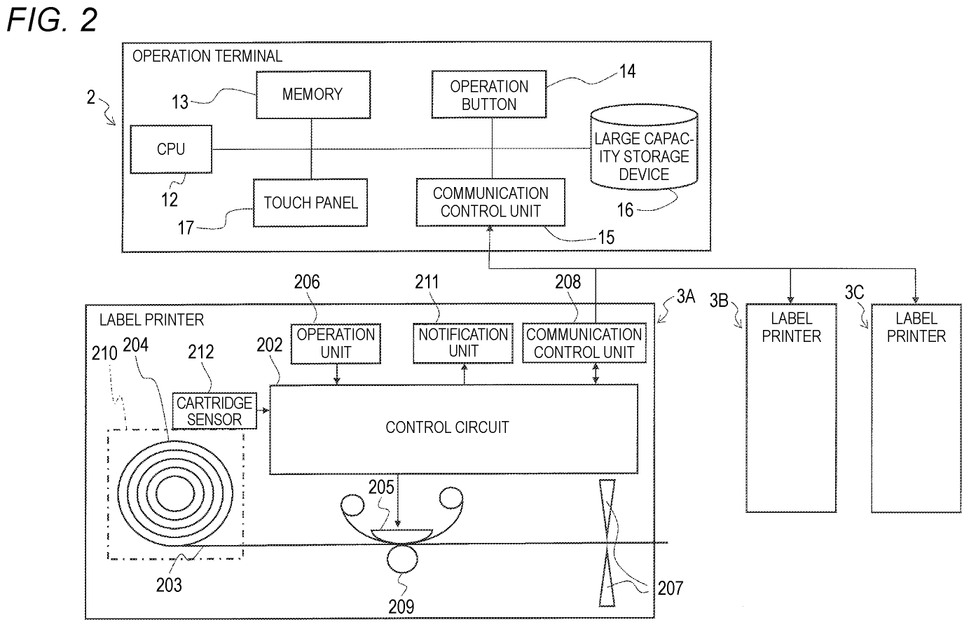

Subsequently, a functional configuration of the printing processing system is described with reference to FIG. 2.

As shown in FIG. 2, the operation terminal 2 includes a CPU 12, a memory 13 including a RAM, a ROM and the like, the operation button 14, a communication control unit 15, a large-capacity storage device 16 such as a flash memory, and the touch panel 17. In the meantime, a display function part of the touch panel 17 corresponds to an example of the display defined in the claims, the communication control unit 15 corresponds to an example of the communication unit, and the CPU 12 corresponds to an example of the computer and second controller. Also, an operation function part of the touch panel 17 and the operation button 14 correspond to an example of the operation unit defined in the claims. Hereinbelow, they are collectively referred to as “the operation unit 14 and the like”.

In the RAM of the memory 13, for example, prim data corresponding to a desired print content to be written on the printed label L, which is produced as a result of the user's appropriate operation on the touch panel 17, is stored.

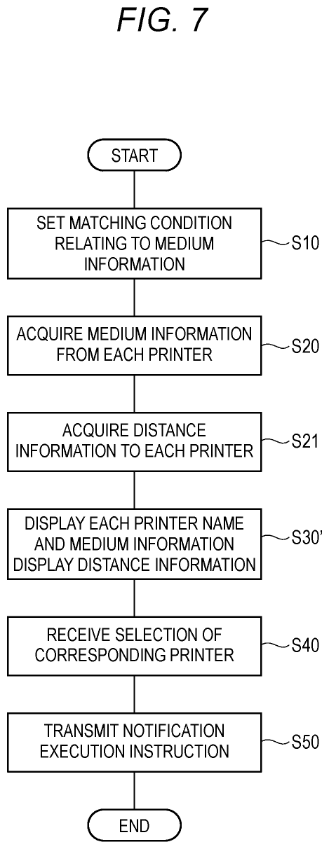

The CPU 12 is configured to control the operation terminal 2 as a whole by executing a variety of programs stored in the ROM of the memory 13 and the large-capacity storage device 16 while using a temporary storing function of the RAM of the memory 13. In the meantime, the programs include a display processing program configured to execute processing shown in flowcharts of FIGS. 7, 9 and 11 to be described later.

The communication control unit 15 is configured to control communication that is performed with the label printer 3.

The large-capacity storage device 16 is, for example, a main body memory but is not limited thereto, and may be an appropriate external memory such as an SD memory card.

The label printer 3 includes a control circuit 202, an operation unit 206, a notification unit 211 (also refer to FIG. 1), a communication control unit 208, a cartridge holder 210 functioning as a tape roll holder unit, a cartridge sensor 212 provided for the cartridge holder 210, a print head 205, a cutter 207. and a conveyor device 209. In the meantime, the control circuit 202 corresponds to an example of the first controller defined in the claims, the communication control unit 208 corresponds to an example of the communication part, the print head 205 corresponds to an example of the printing part, the notification unit 211 corresponds to an example of the notification part, and the conveyor device 209 corresponds to an example of the conveyor.

The control circuit 202 includes a CPU, a RAM, a ROM and the like. In the ROM, a processing program configured to cause the CPU of the control circuit 202 to execute predetermined processing is stored.

The communication control unit 208 is configured to control communication that is performed with the communication control unit 15 of the operation terminal 2.

The cartridge holder 210 can be detachably mounted with a cartridge (not shown) having a tape roll 204 (which actually has a spiral shape but is simplified and shown as concentric circles) having a tape 203 wound thereon. In the meantime, the tape 203 corresponds to an example of the printing medium defined in the claims.

At this time, a type and the like of the cartridge mounted to the cartridge holder 210 are detected by the cartridge sensor 212, and the corresponding information is acquired by the CPU of the control circuit 202. In the present example, the cartridge sensor 212 can also detect a remaining amount of the tape 203 in the cartridge by a well-known method. As a result, the CPU acquires the information from the cartridge sensor 212 to acquire medium information (including medium type information such as a material, a color, a width size and the like and information about a remaining amount of medium, for example) of the tape 203 accommodated in the cartridge mounted to the label printer 3. This processing corresponds to the acquiring of the medium information defined in the claims. In the meantime, instead of the cartridge holder 210, a tape roll holder to which the tape roll 204 itself can be directly detachably mounted may be provided. In this case, the medium information included in the tape roll 204 is detected by an appropriate well-known method and is then output to the CPU.

The conveyor device 209 is provided facing the print head 205, and is configured to convey the tape 203 that is reeled out from the tape roll 204.

The print head 205 is configured to perform, on the tape 203 conveyed by the conveyor device 209, printing based on print data received from the operation terminal 2.

The cutter 207 is configured to cut the printed tape 203 into a predetermined length to form a printed label L (refer to FIG. 1).

<Feature of Present Embodiment>

A feature of the present embodiment is to display on the operation terminal 2 to which of the label printers 3 the tape 203 which the user is looking for is mounted, based on the medium information of the tape 203 in the cartridge acquired by each label printer 3 as described above, In the below, the details are sequentially described.

<Screen Transition on Touch Panel>

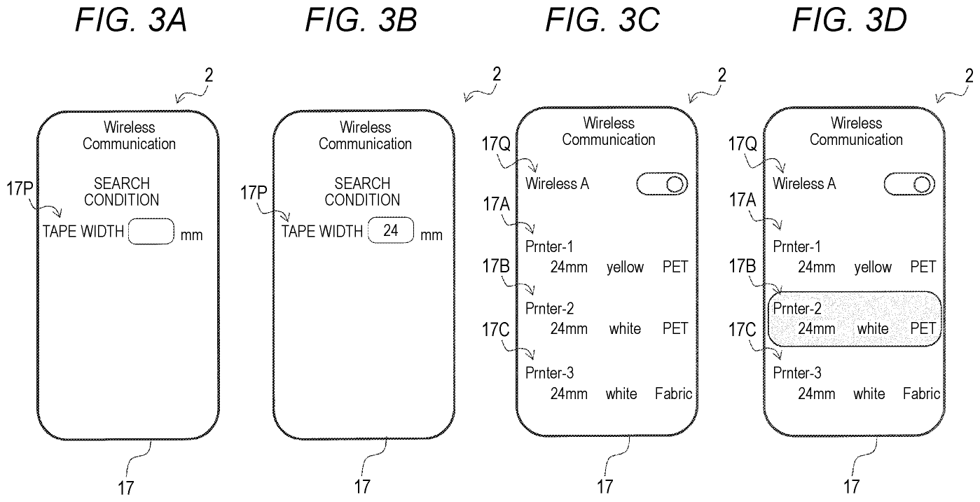

The user operates appropriately the operation unit 14 and the like of the operation terminal 2, for example, thereby displaying a screen, on which a content of the medium information of the tape 203 as a search condition can be input, on the touch panel 17, as shown in FIG. 3A. In the example of FIG. 3A, a tape width input column 17P in which a tape width (width size) of the tape 203 can be input as an example of the medium information is displayed. For example, when the user wants to look for the tape 203 having a tape width 24 [mm], the user inputs “24” in the tape width input column 17P, as shown in FIG. 3B.

At this time, from each of the label printers 3A, 3B and 3C, the identification information of the label printer 3 and the medium information of the tape 203 provided in the mounted cartridge are broadcasted under control of the CPU of the control circuit 202. This processing corresponds to the broadcasting of the acquired medium information and identification information defined in the claims. The broadcasting is performed at predetermined intervals by Bluetooth Low Energy advertising in the Bluetooth communication, for example. In the operation terminal 2, the identification information of each of the label printers 3A, 3B and 3C and the corresponding medium information, which have been broadcasted, are received.

As described in the example of FIG. 3B, when the tape width 24 [mm] of the tape 203 is set as the search condition, information, Which matches the search condition, of the medium information acquired from each label printer 3 is displayed. FIG. 3C depicts an example where the cartridge having the tape 203 of 24 [mm] is mounted to all the label printers 3A, 3B and 3C. That is, in the screen of the touch panel 17 shown in FIG. 3C, a type column 17Q indicating a type of wireless communication with the label printer 3 (in the present example, “Wireless A”) and printer display columns 17A, 17B and 17C are displayed.

In the printer display column 17A, “Printer-1” that is the identification information of the label printer 3A, “24 mm” that is the corresponding tape width, “yellow” indicating that a color of the tape 203 is yellow, and “PET” indicating that a material of the tape 203 is a PET film are displayed based on a result of reception from the label printer 3A.

In the printer display column 17B, “Printer-2” that is the identification information of the label printer 3B, “24 mm” that is the corresponding tape width, “white” indicating that a color of the tape 203 is white, and “PET” indicating that a material of the tape 203 is a PET film are displayed based on a result of reception from the label printer 3B.

In the printer display column 17C, “Printer-3” that is the identification information of the label printer 3C, “24 mm” that is the corresponding tape width, “White” indicating that a color of the tape 203 is white, and “Fabric” indicating that a material of the tape 203 is a fabric are displayed based on a result of reception from the label printer 3C.

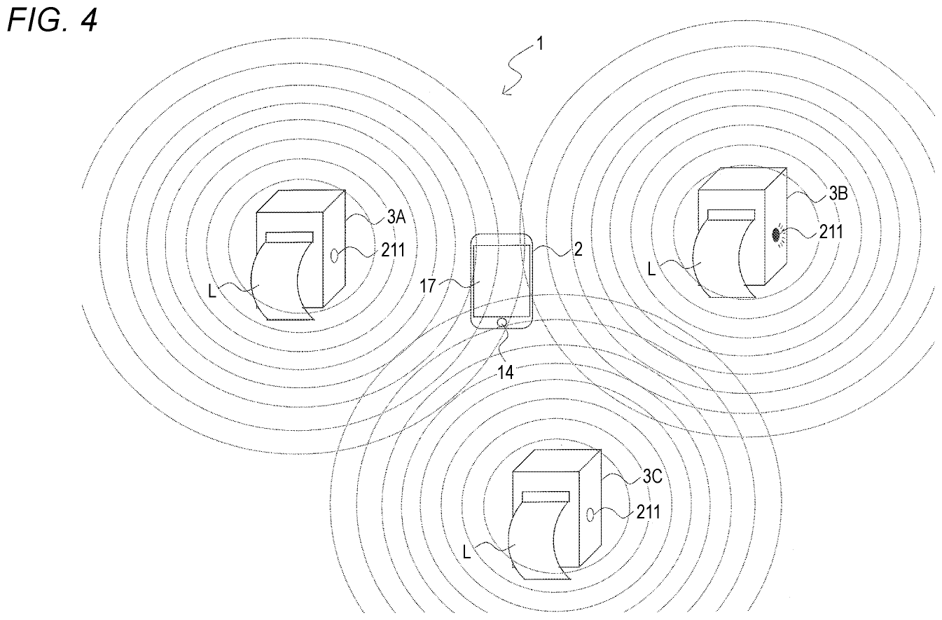

With respect to the display of FIG. 3C, when the user wants to use the tape 203 that is white and made of a PET film, the user operates appropriately the touch panel 17, as shown in FIG. 3D, for example. thereby selecting the label printer 3B in which the corresponding tape 203 is provided. Then, a notification instruction corresponding to the selection result is sent to the label printer 313, so that notification is performed by the notification unit 211 of the label printer 3B, as shown in FIG. 4. For example, when the notification unit 211 has an appropriate light-emitting part, a light-emitting operation is performed by the light-emitting part (refer to FIG. 4). Alternatively, When the notification unit 211 has an appropriate sound generating part, a predetermined sound is generated by the sound generating part. Thereby, the user can recognize that the cartridge corresponding to the user's desired medium information is mounted to the label printer 3B.

<Control Procedure>

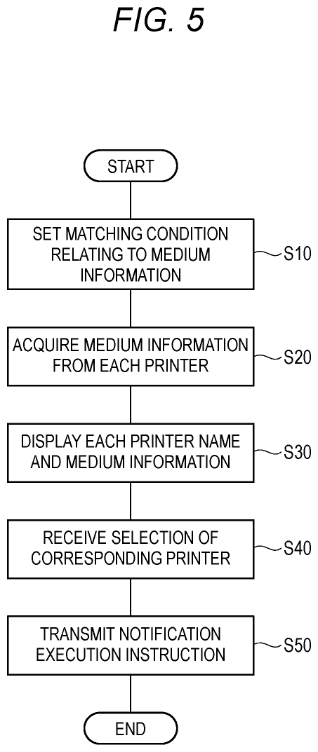

A processing procedure that is executed by the CPU 12 of the operation terminal 2 so as to implement the above configuration is described with reference to a flowchart shown in FIG. 5.

First, in step S10, the CPU 12 sets a desired matching condition relating to the medium information, based on a result that is input as the search condition by the user via the operation unit 14 and the like. In the example of FIGS. 3A and 3B, the tape width=24 of the tape 203 is set as the matching condition. Step S10 corresponds to the setting of the desired matching condition defined in the claims.

Then, in step S20, the CPU 12 receives and acquires, via the communication control unit 15, the medium information of the tape 203 (the medium type information such as a width, a color, a material and the like of a tape and the information about a remaining amount of medium, as described above) of the cartridge tape 203 mounted to each label printer 3 together with the identification information of each label printer 3, which are broadcasted from each label printer 3. Step S20 corresponds to the acquiring of the acquisition result defined in the claims, and the processing that is executed in step S20 corresponds to the receiving of the received result. In the meantime, step S20 may also be executed before step S10.

Then, in step S30, the CPU 12 displays, on the touch panel 17, the medium information and the identification information (for example, a printer name) of each of the corresponding label printers 3 acquired in step S20 in an a manner corresponding to the matching condition set in step S10. In the example of FIGS. 3B and 3C, the medium information of the tape 203 that matches the tape width-24 [mm] as the matching condition and the identification information of the label printer 3 having the tape are limitedly displayed. Step S30 corresponds to the displaying of the display result defined in the claims.

Then, in step S40, the CPU 12 receives a selection (decision) operation of a specific label printer 3 corresponding to the content that the user is looking for, which is performed via the operation unit 14 and the like in correspondence to the display in step S30. At this time, a selection of one label printer 3 (specifically, the identification information) may be received, as shown in FIG. 3D, or a selection of the tape 203 mounted to the label printer 3 may be received. Step S40 corresponds to the receiving of the decision operation defined in the claims.

Then, in step S50, the CPU 12 transmits a notification execution instruction to the specific label printer 3 selected in step S40, via the communication control unit 15. Step S50 corresponds to the transmitting of the execution instruction defined in the claims. Thereby, in the specific label printer 3 having received the notification execution instruction, the predetermined notification operation (light-emitting operation or sound generating operation) is executed by the notification unit 211, under control of the CPU of the control circuit 202. This processing corresponds to the causing of the notification part to execute the predetermined notification operation defined in the claims. Then, the flow is over.

<Effects of Embodiment>

As described above, in the present embodiment, the identification information (for example, a printer name) of the label printer 3 and the medium information of the corresponding tape 203 are broadcasted from each label printer 3 to which the tape 203 is mounted. Then, in the operation terminal 2, the broadcasted identification information and medium information are acquired, and the acquired identification information of each label printer 3 and corresponding medium information are displayed on the touch panel 17.

Thereby, the user who is looking for the tape 203 in use can find out a content of the medium information that the user is looking for, from the display of the touch panel 17, and perform the decision operation of selecting one corresponding tape 203 (or one label printer 3) and setting the one tape as a selection target via the operation unit 14 and the like. In this way, the user can know to which label printer 3 the tape 203 corresponding to the content of the medium information that the user is looking for is attached, so that it is possible to improve convenience for the user.

In the above flow, the matching condition corresponding to the search condition is set in step S10, and the medium information of each label printer 3 is displayed in a manner corresponding to the matching condition in step S30. However, the present disclosure is not limited thereto. For example, step S10 may be omitted. In this case, in step S20, the medium information is acquired from all the label printers 3 within a range in which communication can be performed from the operation terminal 2, and in step S30, all the acquired medium information and the identification information of the corresponding label printers 3 are displayed. Also in this case, the similar effects can also be obtained.

Also, in the present embodiment, particularly, the execution instruction is transmitted to one label printer 3 corresponding to the user's decision operation (in other words, the selection result). Then, the predetermined notification operation is executed in the label printer 3 corresponding to the selection result. Thereby, the user can know certainly that the tape 203 corresponding to the content of the medium information that the user is looking for is mounted to the label printer 3 having performed the notification operation.

Also, in the present embodiment, particularly, the desired matching condition corresponding to the search condition input via the operation unit 14 and the like and relating to the medium information is set (refer to step S10), and the identification information (for example, a printer name) of each label printer 3 and the corresponding medium information are displayed on the touch panel 17 in a display manner corresponding to the set matching condition (refer to step S30). Thereby, when performing the display on the touch panel 17, the medium information of which content is not matched with the matching condition can be prevented from being displayed (refer to the tape width 24 [mm]). Also, although not shown, the medium information of which content is not matched with the matching condition and the identification information of the corresponding label printer can be displayed to be less conspicuous than the medium information of which content is matched with the matching condition and the identification information of the corresponding label printer. As a result, the user can easily find out, from the display of the touch panel 17, the content of the medium information that the user is looking for.

In the meantime, the present disclosure is not limited to the above embodiment, and a variety of changes can be made without departing from the spirit and technical scope of the present disclosure. Hereinbelow, modified embodiments are sequentially described. The parts equivalent to the embodiment are denoted with the same reference signs, and the descriptions thereof are appropriately omitted or simplified.

(1) Case Where Distance To Each Label Printer Is Also Displayed

<Screen Transition on Touch Panel>

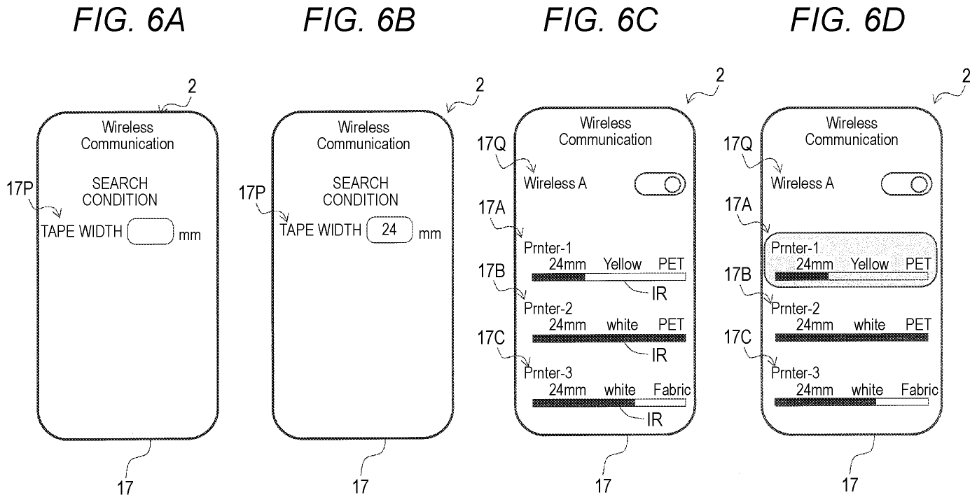

A screen transition on the touch panel 17 of the operation terminal 2 in the present modified embodiment is shown in FIGS. 6A to 6D corresponding to FIGS. 3A to 3D of the above embodiment.

First, in FIG. 6A, the tape width input column 17P is displayed on the touch panel 17, similarly to FIG. 3A. In this state, in FIG. 6B, “24” is input to the tape width input column 17P by the user who wants to look for the tape 203 of the tape width 24 [mm], similarly to FIG-. 3B.

At this time, in the present modified embodiment, distance information between each of the label printers 3A, 3B and 3C and the operation terminal 2, which is detected by a well-known method, is broadcasted from each label printer 3, in addition to the identification information (for example, a printer name) of each of the label printers 3A, 3B and 3C and the corresponding medium information, which are similar to the above embodiment, and the corresponding information is acquired by the operation terminal 2,

In this state, when a tape width is input, as described above, the type column 17Q and the printer display columns 17A, 17B and 17C are displayed on the touch panel 17, in the present modified embodiment, as shown in FIG. 6C, similarly to FIG. 3C.

Then, in the present example, in the printer display column 17A, based on a result of the reception from the label printer 3A, a distance indicator IR indicating a distance from the label printer 3A to the operation terminal 2 by a relative length of a black part of a bar is displayed, in addition to “Printer-1”, “24 mm”, “yellow” and “PET” that are similar to FIG. 3C. In the present example, about one third of the bar is black, which corresponds to a relatively short distance from the label printer 3A to the operation terminal 2.

Similarly, in the printer display column 17B, based on a result of the reception from the label printer 3B, a distance indicator IR of which a bar is entirely black is displayed, which corresponds to a relatively long distance from the label printer 3B to the operation terminal 2, in addition to “Printer-2”, “24 mm”. “white” and “PET” that are similar to FIG. 3C.

Similarly, in the printer display column 17C, based on a result of the reception from the label printer 3C, a distance indicator IR of which about two third of a bar is black is displayed, which corresponds to a medium degree distance from the label printer 3C to the operation terminal 2, in addition to “Printer-3”, “24” “white” and “Fabric” that are similar to FIG. 3C.

In the meantime, instead of the indicator of the graphical display, a numerical value or the like indicative of an actual distance or relative value corresponding to the distance information may be displayed.

In the present modified embodiment, with respect to the display of FIG. 6C, the user who wants to use the white tape 203 made of a PET film material, for example, similarly to the above embodiment, can decide which label printer's cartridge to use by also considering the distance to each label printer 3. In the present example, the label printer 39 (“Printer-2”) of which the content of the medium information is completely matched is far from the operation terminal 2. On the other hand, the label printer 3A (“Printer-1”) of which the content of the median information is not completely matched but is matched to some extent (matched except that the tape color is yellow) is close to the operation terminal 2. As a result, in the present example, as shown in FIG. 6D, the label printer 3A is selected by the user. As a result, the notification instruction is sent to the label printer 3A, and the notification is performed by the notification unit 211 of the label printer 3A (which is not shown).

<Control Procedure>

A processing procedure that is executed by the CPU 12 of the operation terminal 2 so as to implement the above method of the present modified embodiment is shown in FIG. 7. In the flow of FIG. 7, step S21 is newly provided after step S20 of FIG. 5 of the above embodiment, and step S30′ is provided instead of step S30 of FIG. 5.

That is, in the present modified embodiment, the CPU 12 of the operation terminal 2 acquires the medium information from each label printer 3 in step S20 via step S10 similar to FIG. 5, and then proceeds to step S21.

In step S21, the CPU 12 acquires the distance information from each label printer 3 to the operation terminal 2 via the communication control unit 15. The distance information may be included in the broadcasting or may be acquired by new communication that is performed separately from the broadcasting. Step S21 corresponds to the acquiring of the distance information defined in the claims. Then, the CPU 21 proceeds to step S30′.

In step S30′, similarly to step S30, the CPU 12 first displays, on the touch panel 17, the medium information and the identification information (for example, a printer name) of each of the corresponding label printers 3 acquired in step S20 in a manner corresponding to the matching condition set in step S10. In addition to this, the CPU 12 displays, on the touch panel 17, the distance information of each label printer 3 acquired in step S21. In the present modified embodiment, step S30′ corresponds to the displayin2 of the display information defined in the claims.

Step S40 and step S50 that are executed thereafter are similar to FIG. 5, and the descriptions thereof are omitted.

<Effects of Modified Embodiment>

In the present modified embodiment, after the distance information from the operation terminal 2 to each label printer 3 is acquired (refer to step S21), not only the identification information (for example, a printer name) of the label printer 3 and the corresponding medium information but also the acquired distance information is displayed on the touch panel 17. Thereby, when looking for the tape 203 corresponding to the medium information of which content is matched with the user's desired content, as described above, the user can also consider the distance to the tape 203, i.e., the distance to the label printer 3 to which the tape 203 is mounted. Thereby, when two label printers 3 to which the tapes 203 of substantially the same conditions are respectively mounted are found, the label printer that is located at a shorter distance can be selected (refer to the example of FIG. 6D). As a result, it is possible to further improve the convenience for the user.

(2) Case Where Search Condition Is Automatically Set

<Screen Transition on Touch Panel>

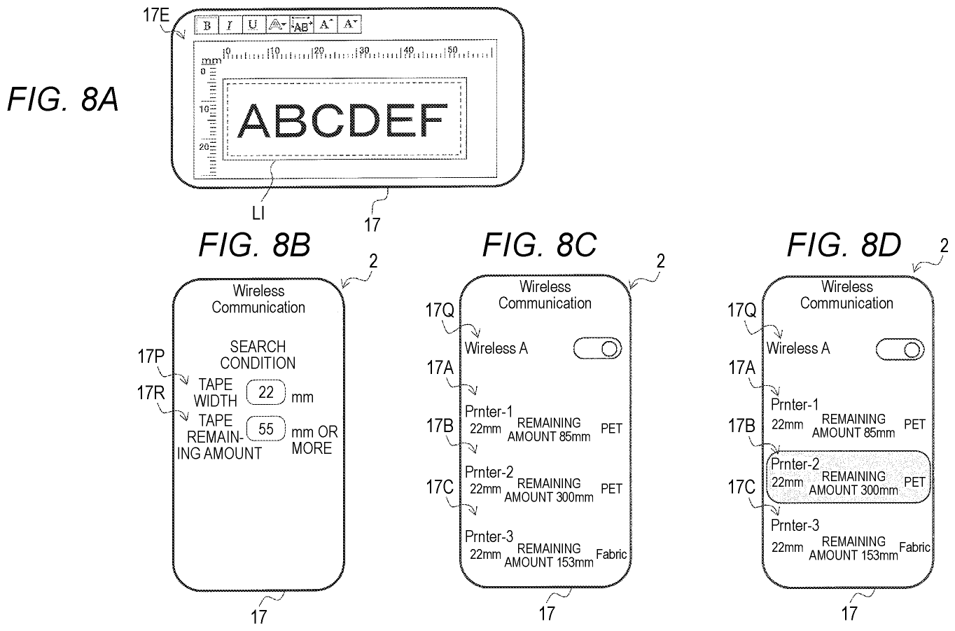

A screen transition on the touch panel 17 of the operation terminal 2 in the present modified embodiment is shown in FIGS. 8A to 8D corresponding to FIGS. 3A to 3D and 6A to 6D.

In the present modified embodiment, the user first operates appropriately the operation unit 14 and the like of the operation terminal 2, for example, thereby displaying an editing screen 17E (FIG. 8A) for editing a print content of the printed label L on the touch panel 17. Then, the user operates appropriately the operation unit 14 and the like, thereby performing an editing operation of the print content. In the example of FIG. 8A, as a result of the editing operation, a label image LI having text characters “ABCDEF” is displayed in the editing screen 17E.

As shown in FIG. 8A, in the present example, a width of the printed label L (in other words, a width of the tape 203) is set to 22 [mm] by the user operation. Also, the “ABCDEF” is input, so that a length of the printed label L of 55 [mm] is required. Therefore, in the present modified embodiment, in a screen of FIG. 8B that is displayed as a result of the user's operation on the operation unit 14 and the like, “22” is automatically input in the tape width input column 17P, as one of the search conditions, Also, in the present example, a tape remaining amount input column 17R is arranged in the screen, as another condition of the search conditions, and “55” is automatically input therein. That is, in the present modified embodiment, a remaining amount of the tape 203 as the medium information being equal to or larger than a required remaining amount necessary for printing it also automatically set as the search condition.

As a result, as the search conditions, the tape width 22 [mm] of the tape 203 and the tape remaining amount of 55 [mm] or more are set. In this case, as shown in FIG. 8C, the information matching the search conditions of the medium information acquired from each label printer 3 is displayed.

FIG. 8C shows an example where the cartridge having the tape 203 of the width 22 [mm] is mounted to all of the label printers 3A, 3B and 3C. Similarly to FIG. 3C, the type column 17Q and the printer display columns 17A, 17B and 17C are displayed on the screen of the touch panel 17.

In the printer display column 17A, based on a result of the reception from the label printer 3A, “Printer-1” that is the identification information of the label printer 3A, “22 mm” that is the corresponding tape width, “85 mm” that is a remaining amount of the corresponding tape 203, and “PET” indicating that a material of the tape 203 is a PET film are displayed.

In the printer display column 17B, based on a result of the reception from the label printer 3B, “Printer-2” that is the identification information of the label printer 3B, “22 mm” that is the corresponding tape width, “300 mm” that is a remaining amount of the corresponding tape 203, and “PET” indicating that a material of the tape 203 is a PET film are displayed.

In the printer display column 17C, based on a result of the reception from the label printer 3C, “Printer-3” that is the identification information of the label printer 3C, “22 mm” that is the corresponding tape width. “153 mm” that is a remaining amount of the corresponding tape 203, and “Fabric” indicating that a material of the tape 203 is a fabric are displayed.

With respect to the display of FIG. 8C, when the user wants to produce a printed label L like the label image LI by using the tape 203 made of a PET film, for example, in the present modified embodiment, the user can decide which label printer's cartridge to use by also considering the remaining amount of the tape 203 in the cartridge mounted to each label printer 3. In the present example, of the label printer 3A (“Printer-1”) and the label printer 3B (“Printer-2”) to which the cartridge of the tape width 22 [mm] is mounted, the remaining amount of the tape 203 is larger in the cartridge of the label printer 3B. As a result, in the present example, as shown in FIG. 8D, the label printer 3B is selected by the user. As a result, the notification instruction is sent to the label printer 3B, and the notification is performed by the notification unit 211 of the label printer 3B (which is not shown)

<Control Procedure>

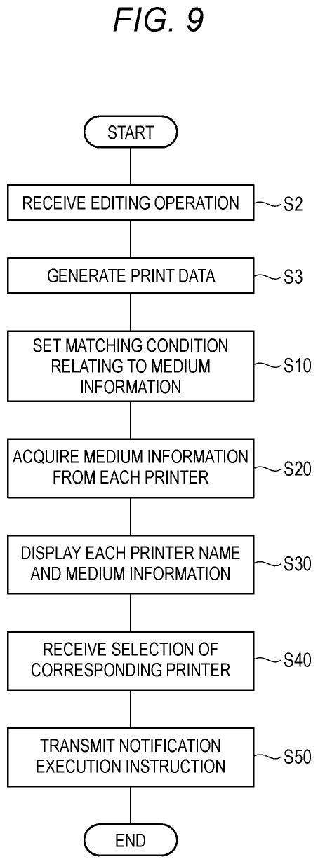

A processing procedure that is executed by the CPU 12 of the operation terminal 2 so as to implement the above method of the present modified embodiment is shown in FIG. 9. In the flow of FIG. 9, step S2 and step S3 are newly provided before step S10 of FIG. 5 of the above embodiment.

That is, first, in step S2, the CPU 12 of the operation terminal 2 receives an editing operation of the user on the editing screen 17E of the touch panel 17 via the operation unit 14 and the like. Step S2 corresponds to the receiving of an operation relating to printing on a printed material defined in the claims.

Then, in step S3, the CPU 12 generates print data for the label printer 3, in accordance with the editing operation received in step S2. Step S3 corresponds to the print data generating procedure defined in the claims. Correspondingly, in subsequent step S10, the CPU 12 sets the matching conditions relating to the medium information, in accordance with the editing operation in step S2 and the print data generated in step S3. In the example of FIGS. 8A and 8B, as described above, the tape width 22 [mm] of the tape 203 and the tape remaining amount of 55 [mm] or more are set as the matching conditions. Also in the present modified embodiment, step S10 corresponds to the setting of the desired matching condition defined in the claims.

Thereafter, in step S30 via step S20, the CPU 12 displays, on the touch panel 17, the medium information acquired in step S20 and the identification information (for example, a printer name) of each of the corresponding label printers 3 in a manner corresponding to the matching conditions set in step S10. In the example of FIGS. 8B and 8C, the medium information of the tape 203, which is matched with the matching conditions of the tape width 22 [mm] and the tape remaining amount of 55 [mm] or more, and the identification information of the label printer 3 having the tape 203 are limitedly displayed. Also in the present modified embodiment, step S30 corresponds to the displaying of the display result defined in the claims.

Step S40 and step S50 that are executed thereafter are similar to FIG. 5, and the descriptions thereof are omitted.

<Effects of Modified Embodiment>

In the present modified embodiment, after the print data is generated by the user operation on the operation unit 14 and the like, when performing the display on the touch panel 17, if a remaining amount of the tape 203 is less than an amount required to print the print data, the medium information of the corresponding tape 203 may not be displayed. Alternatively, the tape having an insufficient remaining amount may be displayed inconspicuously or a mark may be added to only the tape having a sufficient remaining amount or a highlight display may be performed for the same. As a result, the user can find out, from the display on the touch panel 17, the cartridge having the tape 203 by which the printed label L edited by the user can be reliably printed.

(3) Case Where There Is No Cartridge Matching Search Condition

For example, there may be a case where the tape 203 having the medium information of which content is matched with the user's desire is not found because it is not mounted to any of the label printers 3. The present modified embodiment is an example for coping with such case.

<Screen Transition On Touch Panel>

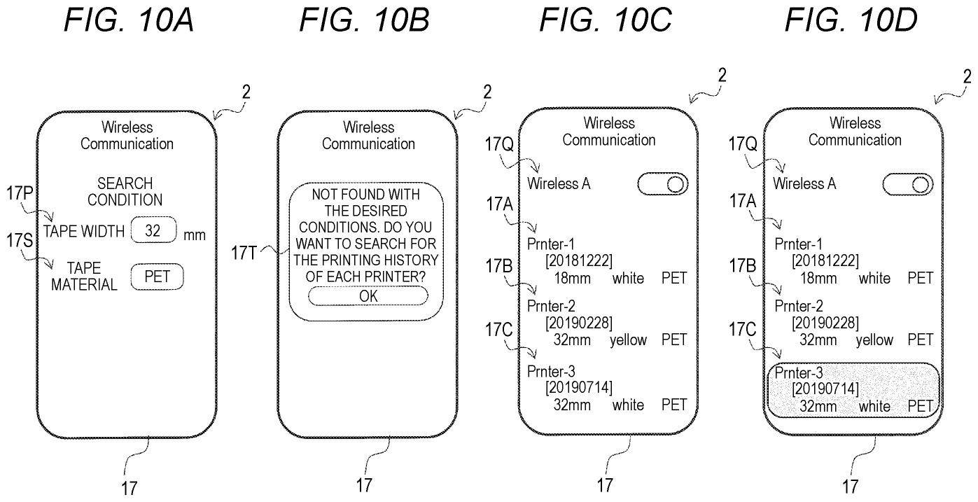

A screen transition on the touch panel 17 of the operation terminal 2 in the present modified embodiment is shown in FIGS. 10A to 10D.

For example, in the example of FIG. 10A, in the present modified embodiment, as the search conditions, a tape width 32 [mm] of the tape 203 is set in the tape width input column 17P and a PET film material of the tape 203 is set in a tape material input column 17S. Although not described in detail, the search conditions are automatically set based on the editing operation of the user, as described above with reference to FIG. 8 in the modified embodiment (2). In the meantime, as described above with reference to FIG. 3 in the above embodiment, the search conditions may also be set based on the operation input of the user via the operation unit 14 and the like.

Herein, in a state where the medium information is acquired in the operation terminal 2 from all the label printers 3 (label printers 3A to 3C, in the above example) within a communication range, there may be a case where the cartridge having the tape 203 matching the search conditions of “the tape width 32 [mm] and a PET film” is not mounted to any of the label printers 3. However, even in this case, if the cartridge having the tape 203 matching the search conditions has been used in the past even once in any one of the label printers 3, there is a high possibility that the corresponding cartridge is still placed in the vicinity of the corresponding label printer 3. Therefore, in the present modified embodiment, in the above case, the touch panel 17 is shifted to a screen shown in FIG. 10B. In this screen, a message column 17T “Not found with the desired conditions. Do you want to search for the printing history of each printer?” is displayed. Then, when an “OK” in the message column 17T is clicked, each printing history accumulated in advance in each label printer 3 is searched for.

That is, in the present modified embodiment, in each label printer 3, when the printed label L is produced while the cartridge is appropriately replaced and used, the medium information of the tape 203 in the cartridge is recorded and stored as a printing history in an appropriate place (for example, a memory in the control circuit). During the search, the printing history stored in each label printer 3 is read out and transmitted to the operation terminal 2.

FIG. 10C depicts a screen that is displayed on the touch panel 17 after the printing history of each label printer 3 transmitted as described above is acquired. In the screen, similarly to the above configuration, the type column 17Q and the printer display columns 17A, 17B and 17C are displayed.

In the printer display column 17A, in the present example, as the printing history received from the label printer 3A, in response to the search, “Printer-1” that is the identification information of the label printer 3A, a character string of “20181222” indicating that the history date is Dec. 22, 2018, “18 mm” that is the corresponding tape width, “white” indicative of a color of the corresponding tape 203, and “PET” indicating that a. material of the tape 203 is a PET film are displayed.

In the printer display column 17B, in the present example, as the printing history received from the label printer 3B, in response to the search, “Printer-2” that is the identification information of the label printer 3B, a character string of “20190228” indicating that the history date is Feb. 28, 2019, “32 mm” that is the corresponding tape width, “yellow” indicative of a color of the corresponding tape 203, and “PET” indicating that a material of the tape 203 is a PET film are displayed.

In the printer display column 17C, in the present example, as the printing history received from the label printer 3C, in response to the search, “Printer-3” that is the identification information of the label printer 3C, a character string of “20190714” indicating that the history date is Jul. 14, 2019, “32 mm” that is the corresponding tape width, “white” indicative of a color of the corresponding tape 203, and “PET” indicating that a material of the tape 203 is a PET film are displayed.

In the printing history display in FIG. 10C, the label printer 3B (“Printer-2”) and the label printer 3C (“Printer-3”) match the search conditions shown in FIG. 10A. However, the date of the printing history in the label printer 3C (in the present example, Jul. 14, 2019) is newer than the data of the printing history in the label printer 3B (in the present example, Feb. 28, 2019). As a result, in the present example, as shown in FIG. 10D, the label printer 3C is selected by the user. As a result, the notification instruction is sent to the label printer 3C, and the notification is performed by the notification unit 211 of the label printer 3C (which is not shown).

<Control Procedure>

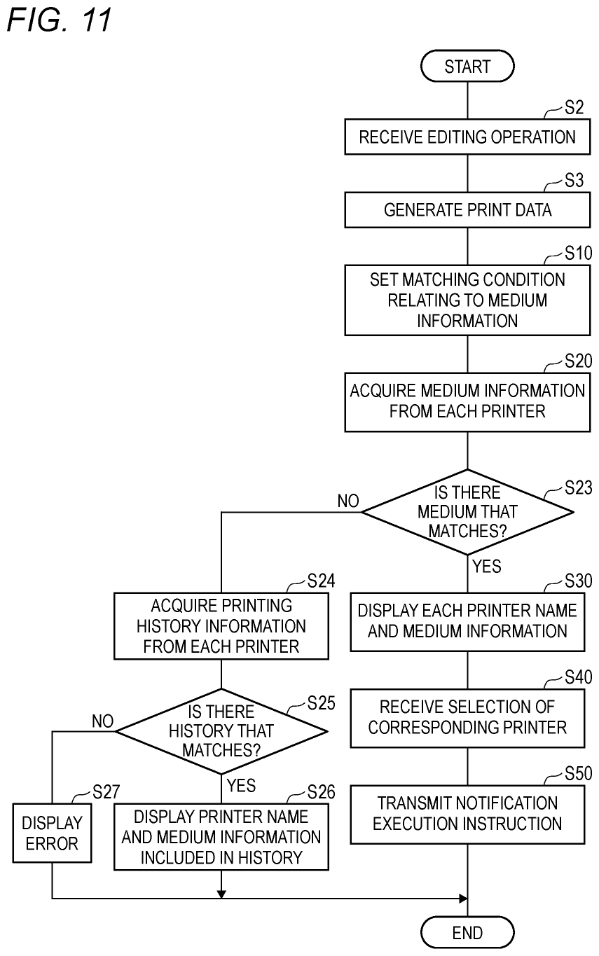

A processing procedure that is executed by the CPU 12 of the operation terminal 2 so as to implement the above method of the present modified embodiment is shown in FIG. 11. In the flow of FIG. 11, step S23 is newly provided between step S20 and step S30 of FIG. 9 of the modified embodiment (2), and step S24, step S25, step S26 and step S27 which branch from step S23 are newly provided.

That is, in step S20 via step S2, step S3 and step S10 similar to FIG. 9, the medium information is acquired from each label printer 3 in the similar manner to the above description, and then the CPU 12 proceeds to step S23,

In step S23, the CPU 12 determines whether there is a cartridge of the tape 203 that satisfies the matching conditions (search conditions) set in step S10 as described above.

When there is a cartridge that satisfies the matching conditions, a determination result in step S23 is affirmative (S23: YES), and the CPU proceeds to step S30 similar to the above description. Step S40 and step S50 that are executed thereafter are similar to FIG. 9 and the like, and the descriptions thereof are omitted.

On the other hand, when there is no cartridge that satisfies the matching conditions, a determination result in step S23 is negative (S23: NO), and the CPU proceeds to step S24.

In step S24, the CPU 12 acquires printing history information indicative of the printing history from each label printer 3 via the communication control unit 15. In the meantime, the printing history information may be acquired from each label printer 3 via the broadcasting, in a similar manner to the acquisition of the medium information, or may be acquired at the same time as the acquisition of the medium information. Alternatively, the printing history information may be acquired by new wireless communication using an appropriate communication method different from the broadcasting. Step S24 corresponds to the acquiring of the printing history information defined in the claims.

Then, in step S25, the CPU 12 determines whether there is a history satisfying the matching conditions set in step S10 in the printing history of each label printer 3 acquired in step S24. When there is no history satisfying the matching conditions, a determination result thereof is negative (S25: NO), and the CPU 12 proceeds to step S27. In step S27, the CPU 12 performs a predetermined error display on the touch panel 17, and this flow is over.

On the other hand, in step S25, when there is a history that satisfies the matching conditions set in step S10, a determination result is affirmative (S25: YES), and the CPU 12 proceeds to step S26. In step S26, the CPU 12 displays, on the touch panel 17, the identification information (for example, a printer name) of the label printer 3 and the medium information included in the history, which correspond to the history satisfying the matching conditions. In the present modified embodiment, step S30 and step S25 correspond to the displaying of the display result defined in the claims. Then, the flow is over.

<Effects of Modified Embodiment>

As described above, in the present modified embodiment, when the information satisfying the matching conditions is not included in the medium information acquired from each label printer 3, the printing history information is acquired from each label printer 3. When the medium information having the content that the user desires is included in the acquired printing history information, i.e., the information satisfying the matching conditions is included in the acquisition result, the medium information and the identification information of the label printer 3, which correspond to the acquisition result, are displayed on the touch panel 17.

Thereby, the user can know the label printer 3 in which the tape 203 having the medium information of the desired content was used in the past. Therefore, the user can find out the cartridge including the tape 203 having the medium information of the desired content with a high probability by going to the place of the label printer 3 and searching the periphery of the place.

In the above, the cases where the present disclosure is applied to the label printer 3 configured to produce the printed label L by performing a desired printing on the tape 203, as the printing apparatus, have been exemplified. However, the present disclosure is not limited thereto. That is, the present disclosure can also be applied to a printer configured to form an image or to print characters on a normal printed sheet of A4, A3, B4, B5 or the like or a portable printer configured to be driven by a battery power supply, as an example of the printing apparatus. That is, the present disclosure can be applied to a printing apparatus having a communication function with the operation terminal 2 via the wireless communication. Similar effects are obtained in these cases.

Also, in the above descriptions, the arrows shown in the respective drawings of FIG. 2 and the like indicate an example of the flow of signals and do not limit the flow direction of the signals.

Also, the flowcharts shown in FIGS. 5, 7, 9 and 11 do not limit the present disclosure to the procedures shown in the flows, and the procedures can be changed or a procedure can be added/omitted without departing from the spirit and technical scope of the invention.

Also, the methods described in the above embodiment and respective modified embodiments can be appropriately combined and used, in addition to the above.

In addition, although not exemplified in detail, the present disclosure can be implemented with diverse modifications without departing from the spirit thereof

What is claimed is:

1. A non-transitory computer-readable storage medium storing a computer program readable by a computer of an operation terminal, the operation terminal including a communication unit connected to, by wireless communication, at least one printing apparatus configured to perform printing on a printing medium mounted thereto, a display configured to display information, an operation unit, and the computer, and the computer program, when executed by the computer, causing the operation terminal to perform:
acquiring an acquisition result including identification information of each of the at least one printing apparatus and medium information of each printing medium mounted to a corresponding printing apparatus of the at least one printing apparatus, the acquisition result being broadcasted from the at least one printing apparatus;
displaying, on the display, a display result including the acquired identification information of each of the at least one printing apparatus and the acquired medium information of each printing medium mounted to the corresponding printing apparatus of the at least one printing apparatus; and
receiving, via the operation unit, a decision operation of selecting one of the at least one printing apparatus or the printing medium mounted to one of the at least one printing apparatus as a selection target, in correspondence to the display result displayed on the display.

2. The non-transitory computer-readable storage medium according to claim 1,
wherein the computer program, when executed by the computer, causes the operation terminal to further perform:
transmitting, by wireless communication via the communication unit, an execution instruction for executing a predetermined notification operation to the one of the at least one printing apparatus corresponding to the selection target for which the decision operation is received.

3. The non-transitory computer-readable storage medium according to claim 1,
wherein the computer program, when executed by the computer, causes the operation terminal to further perform:
setting a desired matching condition relating to the medium information, and
wherein the displaying of the display result includes displaying, on the display, the acquired identification information of each of the at least one printing apparatus and the corresponding acquired medium information in a display manner corresponding to the set matching condition,

4. The non-transitory computer-readable storage medium according to claim 3,
wherein the computer program, when executed by the computer, causes the operation terminal to further perform:
receiving, via the operation unit, an operation relating to printing on the printing medium; and
generating print data corresponding to the received operation,
wherein the setting of the desired matching condition includes automatically setting a condition that a remaining amount of the printing medium as the medium information is equal to or larger than a required remaining amount required to print the print data as the matching condition, and
wherein the displaying of the display result includes displaying, on the display, the acquired identification information of each of the at least one printing apparatus and the corresponding acquired medium information in a display manner corresponding to whether the remaining amount of the printing medium is equal to or larger than the required remaining amount.

5. The non-transitory computer-readable storage medium according to claim 3,
wherein the computer program, when executed by the computer, causes the operation terminal to further perform:
acquiring printing history information of each of the at least one printing apparatus from the at least one printing apparatus, in a case where information satisfying the set matching condition is not included in the acquisition result, and
wherein, in a case where information satisfying the set matching condition is included in the acquired printing history information, the displaying of the display result includes displaying, on the display, the identification information of the printing apparatus and the corresponding medium information which correspond to the acquired printing history information satisfying the set matching condition.

6. The non-transitory computer-readable storage medium according to claim 1,
wherein the computer program, when executed by the computer, causes the operation terminal to further perform:
acquiring distance information which represents a distance to each of the at least one printing apparatus, based on a result of the broadcasting from the at least one printing apparatus, and
wherein the displaying of the display result includes displaying, on the display, information corresponding to the acquired distance information together with the acquired identification information of each of the at least one printing apparatus and the corresponding acquired medium information.

7. A communication processing system comprising:
at least one printing apparatus comprising:
a conveyor configured to convey a printing medium mounted thereto;
a printing part configured to perform printing on the printing medium;
a communication part configured to perform wireless communication with an operation terminal;
a notification part configured to issue a predetermined notification; and
a first controller; and
the operation terminal comprising:
an operation unit;
a display configured to display information;
a communication unit configured to perform the wireless communication with the communication part; and
a second controller,
wherein the first controller of the at least one printing apparatus is configured to:
acquire medium information of the printing medium mounted to the at least one printing apparatus; and
broadcast, via the communication part, the acquired medium information and identification information of the at least one printing apparatus,
wherein the second controller of the operation terminal is configured to:
receive, via the communication unit, a received result including the identification information of each of the at least one printing apparatus and the medium information of each printing medium mounted to a corresponding printing apparatus of the at least one printing apparatus which are broadcasted from the at least one printing apparatus;
display, on the display, a display result including the received identification information of each of the at least one printing apparatus and the received medium information of each printing medium mounted to the corresponding printing apparatus of the at least one printing apparatus;
receive, via the operation unit, a decision operation of selecting one of the at least one printing apparatus or the printing medium mounted to one of the at least one printing apparatus as a selection target, in correspondence to the display result displayed on the display; and
transmit, by wireless communication via the communication unit, an execution instruction for executing a predetermined notification operation to the one of the at least one printing apparatus corresponding to the selection target for which the decision operation is received, and
wherein the first controller of the one of the at least one printing apparatus is configured to cause the notification part to execute the predetermined notification operation based on the transmitted execution instruction.

8. The communication processing system according to claim 7,
wherein the second controller of the operation terminal is further configured to:
set a desired matching condition relating to the medium information, and
wherein the displaying of the display result includes displaying, on the display, the received identification information of each of the at least one printing apparatus and the corresponding received medium information in a display manner corresponding to the set matching condition.

9. The communication processing system according to claim 8,
wherein the second controller of the operation terminal is further configured to:
receive, via the operation unit, an operation relating to printing on the printing medium; and
generate print data corresponding to the received operation,
wherein the setting of the desired matching condition includes automatically setting a condition that a remaining amount of the printing medium as the medium information is equal to or larger than a required remaining amount required to print the print data as the matching condition, and
wherein the displaying of the display result includes displaying, on the display, the received identification information of each of the at least one printing apparatus and the corresponding received medium information in a display manner corresponding to whether the remaining amount of the printing medium is equal to or larger than the required remaining amount.

10. The communication processing system according to claim 8,
wherein the second controller of the operation terminal is further configured to:
acquire printing history information of each of the at least one printing apparatus from the at least one printing apparatus, in a case where information satisfying the set matching condition is not included in the received result, and
wherein, in a case where information satisfying the set matching condition is included in the received printing history information, the displaying of the display result includes displaying, on the display, the identification information of the printing apparatus and the corresponding medium information which correspond to the received printing history information satisfying the set matching condition,

11. The communication processing system according to claim 7,
wherein the second controller of the operation terminal is further configured to:
receive distance information which represents a distance to each of the at least one printing apparatus, based on a result of the broadcasting from the at least one printing apparatus, and
wherein the displaying of the display result includes displaying, on the display, information corresponding to the received distance information together with the received identification information of each of the at least one printing apparatus and the corresponding received medium information.
